(19) United States
(12) Patent Application Publication
(10) Pub. No.: US 2016/0090894 A1
(43) Pub. Date: Mar. 31, 2016

(54) COOLANT CONTROL VALVE

(71) Applicant: AISIN SEIKI KABUSHIKI KAISHA, Kariya-shi (JP)

(72) Inventors: Atsushi SATO, Toyota-shi (JP); Kenichi KOMURO, Obu-shi (JP); Sho OKUNO, Kariya-shi (JP)

(73) Assignee: AISIN SEIKI KABUSHIKI KAISHA, Kariya-shi (JP)

(21) Appl. No.: 14/848,904

(22) Filed: Sep. 9, 2015

(30) Foreign Application Priority Data
Sep. 25, 2014 (JP) 2014-195568

(51) Int. Cl. F01P 7/14; F01P 3/20; F16K 1/42; B01D 35/00; F16K 31/06

(52) U.S. Cl. CPC F01P 7/14; B01D 35/005; F16K 31/0655; F16K 1/42; F01P 3/20

(57) ABSTRACT

A coolant control valve includes a valve body, a valve seat, a biasing member biasing the valve body to a side where the valve seat is positioned, a solenoid making the valve body and the valve seat contact with each other, a control portion controlling an energization condition of the solenoid, and a blockage inhibition mechanism. The valve body and the valve seat are provided at a flow passage of a fluid, the valve body and the valve seat including magnetic bodies for controlling a flow of the fluid by coming in contact with each other and by being away from each other. The valve body includes a through hole into which the fluid flows in a state where the valve body is in contact with the valve seat. The blockage inhibition mechanism inhibits an extraneous material within the fluid from blocking the through hole.

### CROSS REFERENCE TO RELATED APPLICATIONS

This application is based on and claims priority under 35 U.S.C. §119 to Japanese Patent Application 2014-195568, filed on Sep. 25, 2014, the entire content of which is incorporated herein by reference.

### TECHNICAL FIELD

This disclosure generally relates to a coolant control valve.

### BACKGROUND DISCUSSION

A known engine of a vehicle performs, for example, for reducing fuel consumption, a warm-up operation in a case where a temperature of the engine is low and controls the temperature of the engine to be substantially constant after the temperature of the engine increases. In such a case, in a case where the temperature of a coolant is low, an engine cooling system circulates the coolant via a bypass without bypassing a radiator by closing a thermostat valve. In a case where the temperature of the coolant increases, the engine cooling system circulates the coolant via the radiator by opening the thermostat valve to control the temperature of the coolant to be constant.

According to the engine cooling system, in a case where the engine cooling system is provided with a solenoid valve that switches an outlet for the coolant from the engine to be either fully closed or fully opened, the flow of the coolant of the whole cooling system stops completely in a case where the solenoid valve is in the fully-closed state. In this state, because heat inside the engine does not release outside via the coolant, the warm-up of the engine is enhanced. Then, in a case where the engine cooling system detects that the temperature inside the engine comes to be at a predetermined temperature and controls a coil of the solenoid valve to be non-excited, the solenoid valve comes to be in an open state by receiving a fluid pressure of the coolant. Accordingly, the coolant that is not warmed at the outside of the engine flows inside the engine all at once and promotes the cooling of the engine. As such, because the temperature inside the engine decreases steeply, the combustion condition of the engine comes to be unstable.

A known control valve is disclosed in JP 2013-117297A (hereinafter referred to as Patent reference 1). According to Patent reference 1, the control valve comes to be in an open state where the small amount of a fluid flows other than a state where a valve body is in a fully-open state. The control valve disclosed in Patent reference 1 is provided with a first valve body that is formed with a through hole and a second valve body that shifts the through hole of the first valve body to be in a closed state and in an open state. Because only the second valve body of the first and second valve bodies is shifted to be in an open state, the small amount of the fluid can flow via the through hole of the first valve body. Accordingly, in a case where the temperature inside the engine comes to be at a predetermined temperature when the engine starts, the small amount of fluid flows in the engine to decrease the temperature inside the engine slowly. In a case where the temperature inside the engine comes to be at the predetermined temperature again, the valve body comes to be in a fully-open state. Because the normal amount of the fluid flows in the engine, the temperature of the engine is prevented from being decreased steeply.

However, extraneous materials, for example, a scrap metal or a material of formed in place gasket (FIPG) may be mixed with the coolant at a flow passage of the coolant within the cooling system of the engine. Because the extraneous materials block the through hole of the valve body, the through hole for flowing the small amount of the fluid, the valve body cannot flow the small amount of the fluid.

A need thus exists for a coolant control valve which is not susceptible to the drawback mentioned above.

### SUMMARY

According to an aspect of this disclosure, a coolant control valve includes a valve body, a valve seat, a biasing member biasing the valve body to a side where the valve seat is positioned, a solenoid generating a magnetic force by being energized, the solenoid making the valve body and the valve seat contact with each other, a control portion controlling an energization condition of the solenoid, and a blockage inhibition mechanism. The valve body is provided at a flow passage of a fluid, the valve body including a magnetic body for controlling a flow of the fluid by coming in contact with the valve seat and by being away from the valve seat. The valve seat is provided at the flow passage of the fluid, the valve seat including the magnetic body for controlling the flow of the fluid by coming in contact with the valve body and by being away from the valve body. The valve body includes a through hole into which the fluid flows in a state where the valve body is in contact with the valve seat. The blockage inhibition mechanism inhibits an extraneous material within the fluid from blocking the through hole.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view schematically illustrating a construction of an engine cooling system according to embodiments disclosed here;

FIG. 2 is a cross sectional view of a coolant control valve of the first embodiment;

FIG. 3 is a cross sectional view of a coolant control valve of a second embodiment, the coolant control valve being in a closed state;

FIG. 4 is a cross sectional view of the coolant control valve of the second embodiment, the coolant control valve being in an open state;

FIG. 5 is a cross sectional view of a coolant control valve of a first modified example of the second embodiment;

FIG. 6 is a cross sectional view of the coolant control valve of a second modified example of the second embodiment;

FIG. 7 is a cross sectional view of a coolant control valve of a third embodiment;

FIG. 8 is a plan view of a removal portion;

FIG. 9 is a view illustrating a state where an extraneous material blocks the coolant control valve of the third embodiment; and

FIG. 10 is a view illustrating a state where the extraneous material is removed from the coolant control valve of the third embodiment.

### DETAILED DESCRIPTION

Embodiments of a coolant control valve for a vehicle will hereunder be explained with reference to the drawings.

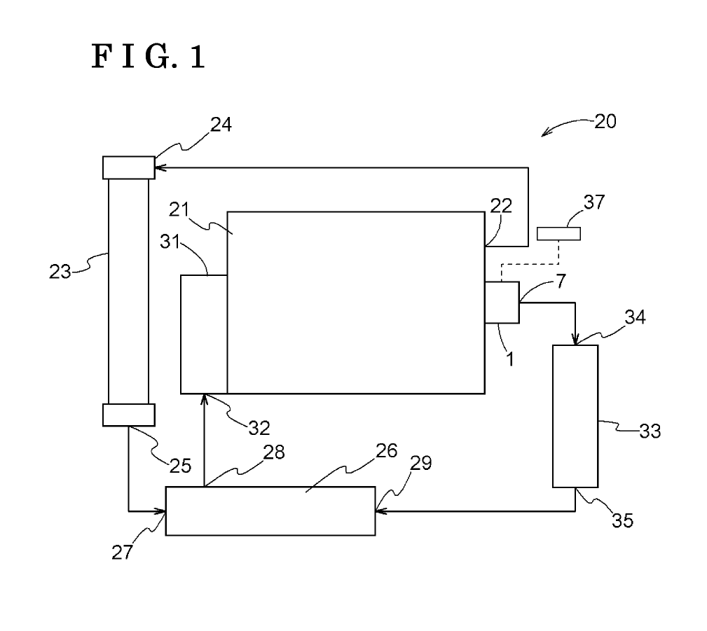

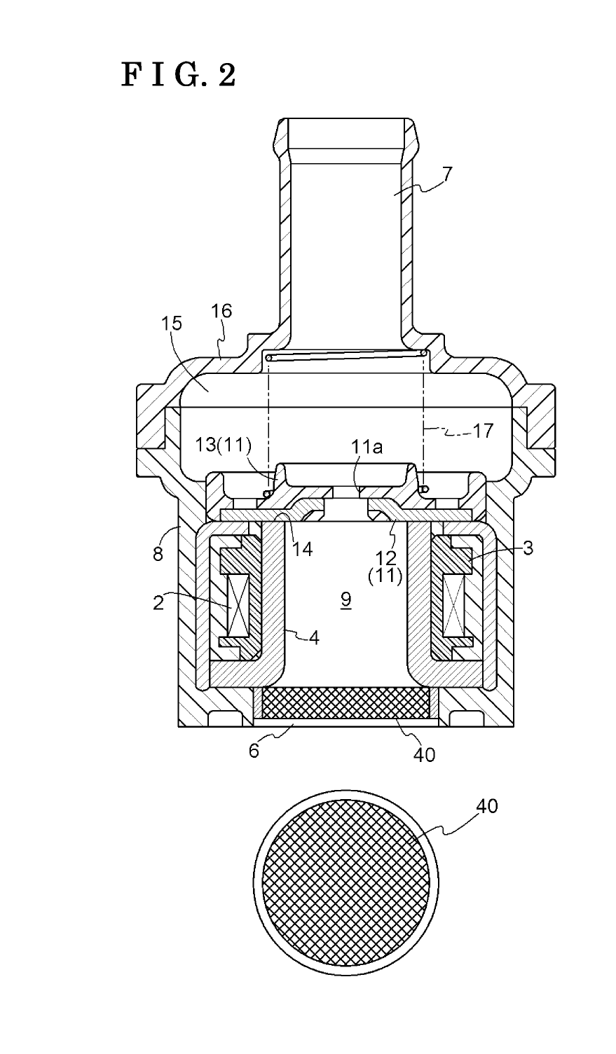

A first embodiment of the coolant control valve will be explained. As shown in FIG. 1, a coolant (coolant liquid) outlet port 22 of an engine 21 is connected to an inlet port 24 of a radiator 23. An outlet port 25 of the radiator 23 is connected to an inlet port 27 of a thermostat valve 26. An outlet port 28 of the thermostat valve 26 is connected to a suction port 32 of an electric pump 31. A discharge port of the electric pump 31 is connected to a coolant (coolant liquid) inlet port of the engine 21. An outlet port for heater of the engine 21 is connected to an inlet port 6 (see FIG. 2) of a coolant control valve 1. An outlet port 7 of the coolant control valve 1 is connected to an inlet port 34 of a heater core 33. An outlet port 35 of the heater core 33 is connected to a bypass inlet port 29 of the thermostat valve 26. The bypass inlet port 29 is communicated with an outlet port 28.

As shown in FIG. 2, the coolant control valve 1 is provided with a housing 8, a valve body 11, a valve seat 14, a coil spring 17 and a solenoid 2. The valve body 11 and the valve seat 14 being provided at a flow passage (an in-valve flow passage 9) of a fluid include magnetic bodies and control the flow of the fluid by coming in contact with each other and by separating from each other. The coil spring 17 serves as a biasing member biasing the valve body 11 to a side where the valve seat 14 is positioned. The solenoid 2 generates the magnetic force by being energized and makes the valve body 11 and the valve seat 14 contact with each other. The coolant control valve 1 includes a control portion 37 that controls an energized condition of the solenoid 2 (see FIG. 1).

The valve body 11 includes a magnetic body 12 and a resin body 13 that covers the magnetic body 12. The magnetic body 12 is positioned so as to be exposed to the valve seat 14. A through hole 11a for the fluid is provided at the valve body 11. The fluid flows in the through hole 11a in a state where the valve body 11 is in contact with the valve seat 14.

The housing 8 includes an inlet port 6, an outlet port 7, an opening portion 15 and a cover body 16. The opening portion 15 is coaxially positioned with the inlet port 6 to face therewith. The cover body 16 tightly closes or seals the opening portion 15. The outlet port 7 is positioned in a forwarding direction of the fluid from the inlet port 6.

The solenoid 2 is electrically connected to a driving circuit via a connector and is wound by a bobbin 3 that is made of magnetic body, for example, iron at an outer side of an inner diameter portion of the bobbin 3. The solenoid 2 is configured with a conductive wire that is positioned between the inner diameter portion and an outer diameter portion of the bobbin 3. The bobbin 3 is positioned within a housing that is provided with the inlet port 6 and the outlet port 7. A cylindrical core 4 is positioned at a position where the inner diameter portion of the bobbin 3 is positioned. The in-valve flow passage 9 (i.e., serving as a flow passage) is positioned in an internal space of the core 4 and is communicated with the inlet port 6.

The valve body 11 is made of magnetic body, for example, iron and is slidably supported with a cover body 16. The cover body 16 tightly closes the opening portion 15 of the housing 8 that is positioned opposite to the inlet port 6. The valve seat 14 that comes to be in contact with the valve body 11 is positioned at a flange surface that is positioned opposite to the inlet port 6 relative to the bobbin 3. A coil spring 17 serving as a biasing mechanism is positioned between the valve body 11 and the cover body 16 and biases the valve body 11 in a direction where the valve seat 14 is positioned.

When the solenoid 2 is excited by being energized, the valve body 11 is attracted to the valve seat 14. Because the valve body 11 and the valve seat 14 are maintained in a contacted state with each other, the valve body 11 comes to be in a closed state.

The fluid pressure is not generated at the inlet port 6 in a state where the electric pump 31 is halted. Accordingly, the valve body 11 is biased with the biasing force of the coil spring 17 and is maintained in a closed state where the valve body 11 is in contact with the valve seat 14 (FIG. 2). Alternatively, the electric pump 31 of the embodiment may be configured by a mechanical pump.

When the engine 21 starts, the solenoid 2 is excited by being energized. The attractive force acts upon the valve body 11 that is made of magnetic body. The valve body 11 of the coolant control valve 1 receives the attractive force of the solenoid 2 and the biasing force of the coil spring 17. Thus, the valve body 11 is maintained in a contact state (closed state) with the valve seat 14. Because the through hole 11a of the valve body 11 is opened, a small amount of the fluid flows via the through hole 11a of the valve body 11 when the fluid pressure generated by the exhaustion from the electric pump 31 acts upon the valve body 11.

For example, when the temperature within the engine 21 increases to a predetermined temperature level and when the supply requirement of the fluid is applied to the coolant control valve 1, the electric pump 31 is activated and the fluid pressure is generated by the exhaustion of the fluid. Thus, the small amount of the fluid flows via the through hole 11a of the valve body 11. When the temperature within the engine 21 further increases, the control portion 37 controls the energizing current value of the solenoid 2 to be reduced. Thus, the valve body 11 moves in an opening direction by receiving the fluid pressure.

As such, because a coolant temperature gauge detects that the temperature within the engine 21 comes to be at the predetermined temperature level, the small amount of the coolant can be flown into the engine 21 via the through hole 11a of the coolant control valve 1. Thus, the temperature within the engine 21 decreases slowly immediately after the supply of the coolant to the engine 21. As a result, the steep decrease of the temperature within the engine 21 can be prevented and the combustion of the engine 21 can be stably performed.

Extraneous materials, for example, scrap metal or a material of a formed in place gasket (FIPG) can be existed at a coolant flow passage of the cooling system of the engine 21. In a case where the extraneous materials enter into the through hole 11a of the valve body 11, the through hole 11a may become blocked or obstructed. Thus, the coolant control valve 1 is provided with an extraneous material collection portion 40 that serves as a blockage inhibition mechanism that inhibits the blockage of the through hole 11a. The extraneous material collection portion 40 is disposed at a position away from the through hole 11a and collects the extraneous materials. According to the embodiment, the extraneous material collection portion 40 includes a mesh, or is formed in a mesh shape. Each cell of the mesh is smaller than the through hole 11a. The extraneous material collection portion 40 is positioned close to the inlet port 6 that is away from the valve body 11.

Because extraneous materials within the fluid are collected by the extraneous material collection portion 40, the extraneous materials are inhibited from blocking the through hole 11a by entering into the through hole 11a. Thus, the small amount of the fluid can be flown stably via the through hole 11a of the valve body 11. Because the extraneous material collection portion 40 includes the mesh, or is formed in the mesh shape, the extraneous material collection portion 40 can be easily formed.

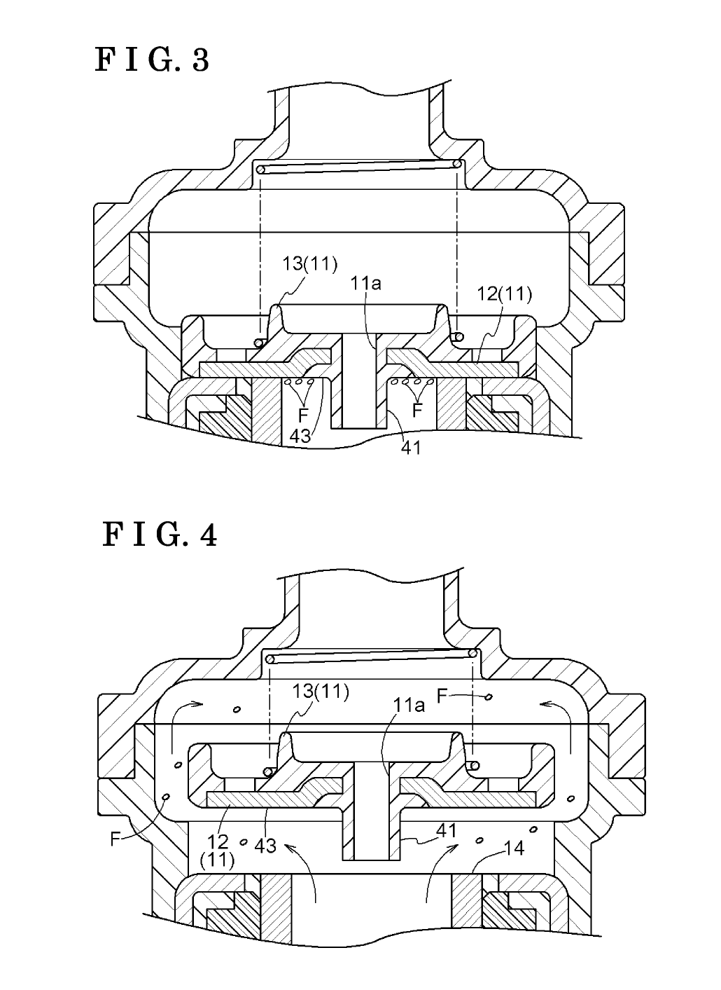

A second embodiment of the coolant control valve 1 will hereunder be explained. According to the second embodiment, as shown in FIG. 3, the through hole 11a of the valve body 11 is provided at a tubular portion 41 that is protrudingly formed from a portion of the valve body 11 to an upstream side in a flow direction of the fluid. In the valve body 11, a surface portion 43 (i.e., serving as a blockage inhibition mechanism and an extraneous material collection portion) is positioned at an outer periphery of the tubular portion 41 and is positioned orthogonal to the flow direction of the fluid. Extraneous materials F move from a distal end (upstream side) towards a portion of the tubular portion 41, the portion positioned at a downstream side, and are collected by the surface portion 43 of the valve body 11. That is, the surface portion 43 serves as the extraneous material collection portion.

According to the coolant control valve 1, because most of the fluid flows toward the surface portion 43 of the valve body 11, the surface portion 43 can collect the extraneous materials F. The fluid reaching the surface portion 43 flows back toward the through hole 11a that is provided at the tubular portion 41 of the valve body 11. However, because the extraneous materials F collected by the surface portion 43 that is away from the through hole 11a are separated from the fluid, the extraneous materials F less likely enter into the through hole 11a of the tubular portion 41. Because the tubular portion 41 is protrudingly formed at the upstream side in the flow direction of the fluid, the extraneous materials F less likely enter into the through hole 11a directly.

As shown in FIG. 4, in a state where the valve body 11 is open, or is in an open state, the extraneous materials F collected by the surface portion 43 flow, with the fluid, from a circumference of the valve body 11 to the downstream side. Thus, the extraneous materials F collected by the surface portion 43 do not flow back to enter into the through hole 11a of the valve body 11.

A first modified example of the second embodiment will hereunder be explained.

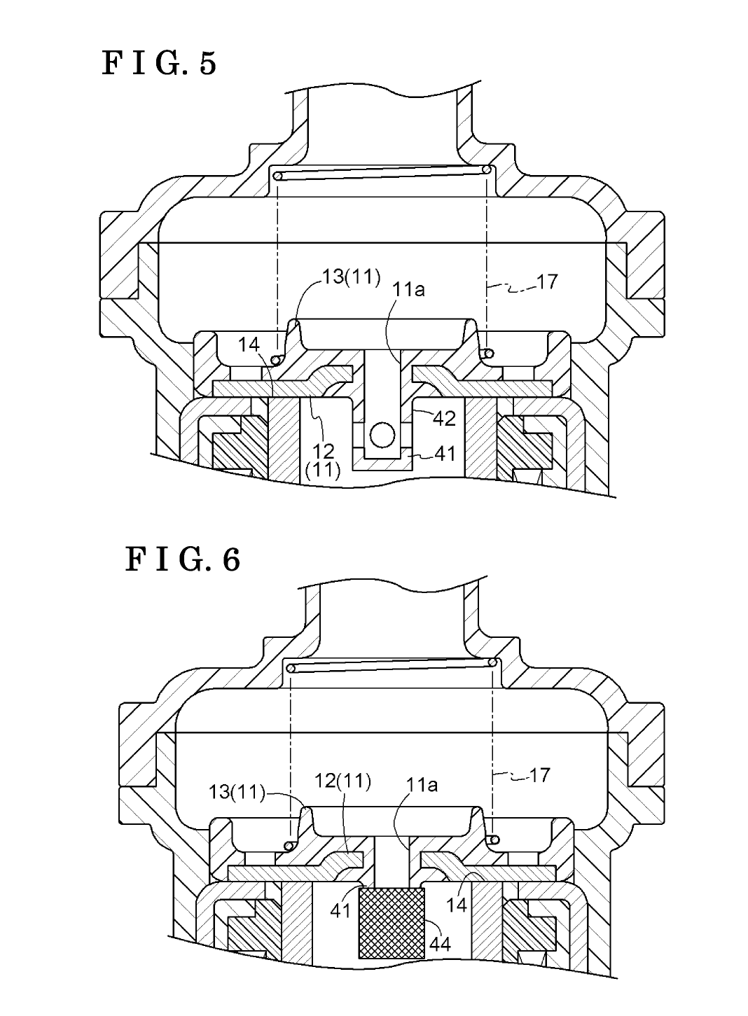

As shown in FIG. 5, at least one through hole 11a may be provided to be positioned through a wall portion 42 of the tubular portion 41 instead of being provided at the end surface of the tubular portion 41, the end surface orthogonal to the flow direction. FIG. 5 shows an example in which the four through holes 11a are equally spaced in a circumferential direction of the wall portion 42 of the tubular portion 41. In a case where the through hole 11a is provided to be positioned through the wall portion 42 of the tubular portion 41, the through hole 11a does not open in the flow direction. Thus, it comes to be difficult for the extraneous materials to enter from the through hole 11a directly. Accordingly, the extraneous materials are inhibited from blocking the through hole 11a. In a case where more than one through hole 11a is provided, the fluid may be securely maintained in the flow state even in a case where one of the through holes 11a is blocked by the extraneous materials.

A second modified example of the second embodiment will hereunder be explained. As shown in FIG. 6, a filter 44 (i.e., serving as a blockage inhabitation mechanism, an extraneous material collection portion) may cover a portion of the tubular portion 41, the portion positioned at the upstream side. In this case, the shape and the position of the through hole 11a provided at the tubular portion 41 are not limited.

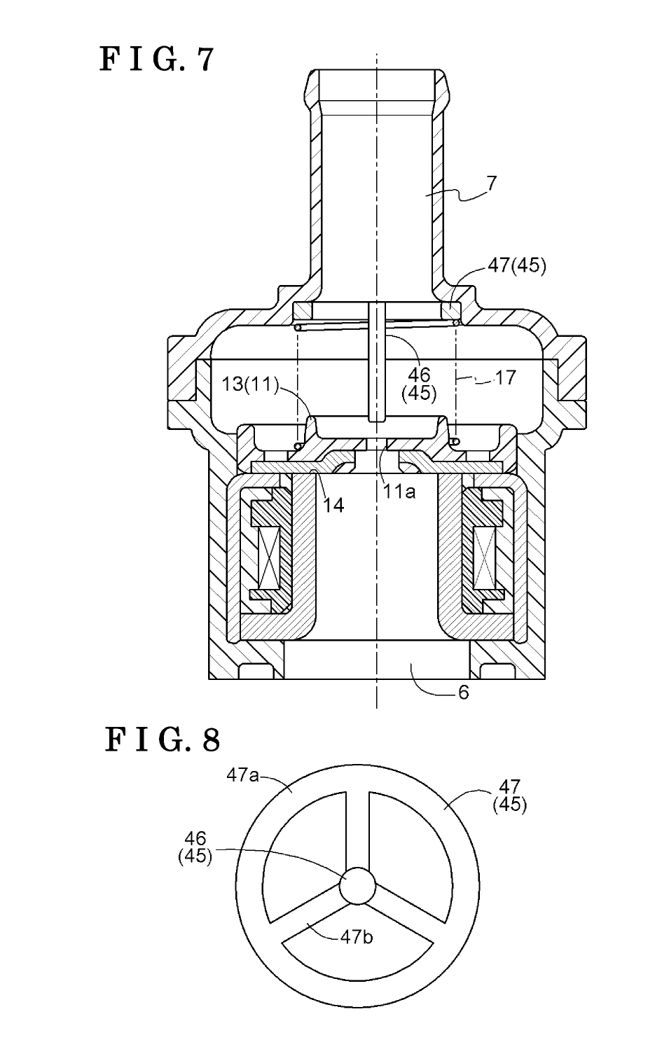

A third embodiment of the coolant control valve 1 will hereunder be explained. According to the third embodiment, as shown in FIGS. 7 to 10, the coolant control valve 1 includes a removal portion 45 that serves as the blockage inhibition mechanism of the through hole 11a and that removes the extraneous materials blocking the through hole 11a. The removal portion 45 is held at a portion of the valve body 11, the portion positioned at the downstream side and is provided with a stick member 46 (i.e., serving as a removal portion) and a support member 47 (i.e., serving as a removal portion). The stick member 46 enters into the through hole 11a of the valve body 11. The support member 47 includes an annular portion 47a and a plurality of connection portions 47b. The respective connection portions 47b extend from the annular portion 47a to a center portion of the support member 47. The stick member 46 is provided at a center portion of the annular portion 47a. The connection portions 47b connect the annular portion 47a and the stick member 46. The stick member 46 extends in the flow direction of the fluid. The support member 47 is fixed to the cover body 16. The stick member 46 is provided at a position facing the through hole 11a in a case where the valve body 11 is closed, or is in a closed state.

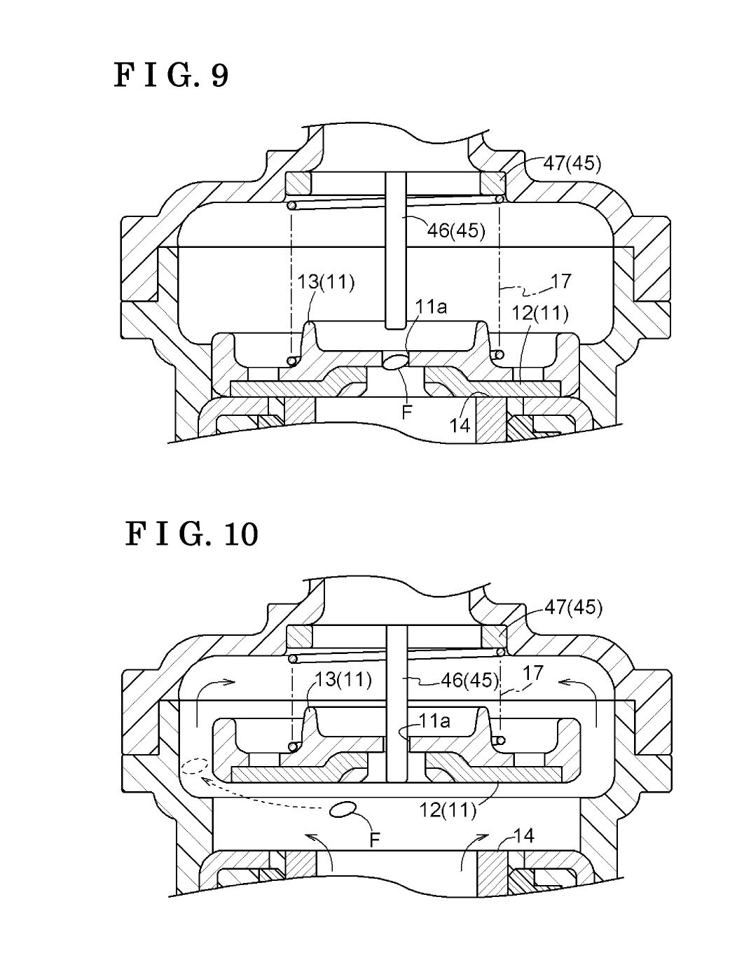

As shown in FIG. 9, in a case where the valve body 11 is closed, or is in the closed state, the extraneous materials F may be retained at the through hole 11a and may block the through hole 11a. In such a case, when the valve body 11 opens, or comes to be in the open state, the stick member 46 of the removal portion 45 enters into the through hole 11a. Thus, the extraneous materials F are removed from the through hole 11a and are flown to the downstream side with the fluid (FIG. 10).

As such, in a case where the extraneous materials block the through hole 11a, the stick member 46 may be able to remove the extraneous materials easily from the through hole 11a by entering in to the through hole 11a of the valve body 11.

Because the coolant temperature gauge detects, for example, the steep increase of the temperature within the engine 21, the valve body 11 opens, or moves to an open state. In a case where the extraneous materials F positioned in the through hole 11a block the through hole 11a, the stick member 46 may enter into the through hole 11a in a case where the valve body 11 remains in the closed state.

According to the aforementioned embodiments, the coolant control valve 1 opens and closes the flow passage to the heater core 23. Alternatively, the coolant control valve 1 is applicable to the thermostat valve 26 that opens and closes the fluid passage to the radiator 23.

According to the aforementioned embodiments, the coolant control valve 1 serves as a cooling system of the engine 21. Alternatively, the coolant control valve 1 is applicable to a cooling system of a catalyst that is positioned at the exhaustion tube or to a liquid-cooled oil cooler. Alternatively, the coolant control valve 1 is applicable to a cooling system of a heat source, for example, a motor, an inverter, a secondary cell, and the fuel cell or is applicable to an exhaust heat recovery system.

The coolant control valve 1 of the embodiments is applicable to a variety of cooling subjects of the vehicle of any kind.

According to the aforementioned embodiments, the coolant control valve (1) includes the valve body (11), the valve seat (14), the biasing member (the coil spring 17) biasing the valve body (11) to a side where the valve seat (14) is positioned, the solenoid (2) generating the magnetic force by being energized, the solenoid (2) making the valve body (11) and the valve seat (14) contact with each other, the control portion (37) controlling the energization condition of the solenoid (2), and the blockage inhibition mechanism (the extraneous material collection portion 40, the surface portion 43, the filter 44, the removal portion 45). The valve body (11) is provided at the flow passage (the in-valve flow passage 9) of a fluid, the valve body (11) including the magnetic body for controlling the flow of the fluid by coming in contact with the valve seat (14) and by being away from the valve seat (14). The valve seat (14) is provided at the flow passage (the in-valve flow passage 9) of the fluid, the valve seat (14) including the magnetic body for controlling the flow of the fluid by coming in contact with the valve body (11) and by being away from the valve body (11). The valve body (11) includes the through hole (11a) flowing the fluid in a state where the valve body (11) is in contact with the valve seat (14). The blockage inhibition mechanism (the extraneous material collection portion 40, the surface portion 43, the filter 44, the removal portion 45) inhibits an extraneous material (F) within the fluid from blocking the through hole (11a).

According to the aforementioned construction of the embodiments, because the valve body 11 includes the through hole 11a into which the fluid flows in a state where the valve seat 14 is in contact with the valve body 11, the coolant control valve 1 can switch a state where the fluid flows by the fully-opened valve body 11 and a state where the small amount of the fluid flows via the through hole 11a of the valve body 11. Accordingly, in a case where the temperature inside the engine 21 comes to be at the predetermined temperature when starting the engine 21, the small amount of the fluid flows in the engine 21 to decrease the temperature inside the engine 21 slowly. In a case where the temperature inside the engine 21 comes to be at the predetermined temperature again, the valve body 11 comes to be in the fully-opened state to flow in the normal amount of the fluid to the engine 21. Accordingly, the steep decrease of the temperature inside the engine 21 can be prevented.

According to the aforementioned construction of the embodiments, because the blockage inhibition mechanism inhibiting the blockage of the through hole 11a by the extraneous material (F) within the fluid is provided, the through hole 11a is inhibited from being blocked by the extraneous material (F) even in a case where the extraneous material (F), for example, scrap metal and the material of FIPG are mixed with the coolant. Thus, the small amount of the fluid can flow stably via the through hole 11a of the valve body 11.

According to the aforementioned embodiments, the blockage inhibition mechanism (the extraneous material collection portion 40, the surface portion 43, the filter 44) includes the extraneous material collection portion (the extraneous material collection portion 40, the surface portion 43, the filter 44) collecting the extraneous material (F) at the position away from the through hole (11a).

According to the aforementioned construction of the embodiments, because the extraneous material collection portion (the extraneous material collection portion 40, the surface portion 43, the filter 44) collects the extraneous material F at the position away from the through hole 11a, the extraneous material F can be inhibited from entering into the through hole 11a. Thus, the small amount of the fluid can flow stably via the through hole 11a of the valve body 11.

According to the aforementioned embodiments, the extraneous material collection portion (the extraneous material collection portion 40, the filter 44) includes the mesh and each cell of the mesh is smaller than the through hole (11a).

According to the aforementioned construction of the embodiments, because the extraneous material collection portion 40 includes the mesh, or is formed in the mesh shape and each cell of the mesh is smaller than the through hole 11a, the extraneous material F that tends to block the through hole 11a can be collected. Accordingly, the through hole 11a can be securely prevented from being blocked. Because the extraneous material collection portion 40 includes the mesh, or is formed in the mesh shape, the extraneous material collection portion 40 can be easily formed.

According to the aforementioned embodiments, the coolant control valve (1) further includes the tubular portion (41) being protrudingly formed from the portion of the valve body (11) to the upstream side in the flow direction of the fluid. The through hole (11a) is provided at the tubular portion (41). The extraneous material collection portion (the surface portion 43) is provided at the surface portion (43), the surface portion (43) being provided radially outward of the outer circumference of the tubular portion (41) relative to forward and rearward directions of the tubular portion (41), the surface portion (43) being provided orthogonal to the flow direction of the fluid.

According to the aforementioned construction of the embodiments, the through hole 11a is provided at the tubular portion 41 being protrudingly formed from the portion of the valve body 11 to the upstream side in the flow direction of the fluid. The extraneous collection portion (the surface portion 43) is provided at the surface portion 43 that is provided radially outward of the outer circumference of the tubular portion 41 relative to a forward and rearward direction of the tubular portion 41, the surface portion 43 being provided orthogonal to the flow direction of the fluid. Accordingly, most of the fluid flows to the surface portion 43 of the valve body 11. The fluid flows back to the through hole 11a of the valve body 11 after the surface portion 43 collects the extraneous material (F). Thus, the extraneous material (F) may rarely enter into the through hole 11a provided at the tubular portion 41. Accordingly, the extraneous material (F) may be inhibited from entering into the through hole 11a by the tubular portion 41 and the surface portion 43 of the valve body 11.

According to the aforementioned embodiments, the tubular portion (41) includes the wall portion (42) being provided at the outer circumference of the tubular portion (41). The through hole (11a) is positioned through the wall portion (42) of the tubular portion (41).

According to the aforementioned construction of the embodiments, the tubular portion 41 include the wall portion 42 being provided at the outer circumference of the tubular portion 41 and at least one of the through holes 11a is positioned through the wall portion 42 of the tubular portion 41. Accordingly, the extraneous material (F) may rarely enter into the through hole 11a directly. The extraneous material (F) can be inhibited from blocking the through hole 11a.

According to the aforementioned embodiments, the extraneous material (F) is removed in a case where the fluid flows and in a case where an energizing current value of the solenoid (2) is reduced.

According to the aforementioned construction of the embodiments, the extraneous material F may be removed from the through hole 11a easily even in a case where the extraneous material F block the through hole 11a.

According to the aforementioned embodiments, the blockage inhibition mechanism (the removal portion 45) includes the removal portion (the stick member 46, the support member 47) removing the extraneous material (F) blocking the through hole (11a).

According to the aforementioned construction of the embodiments, because the blockage inhibition mechanism includes the removal portion (the stick member 46, the support member 47) removing the extraneous material (F) blocking the through hole 11a, the removal portion can remove the extraneous material F even in a case where the extraneous material F enter into the through hole 11a and block the through hole 11a. Accordingly, the through hole 11a can be inhibited from being blocked by the extraneous material F.

According to the aforementioned embodiments, the removal portion (the stick member 46, the support member 47) includes the stick member (46) entering into the through hole (11a) of the valve body (11).

According to the aforementioned construction of the embodiments, because the removal portion (the stick member 46, the support member 47) includes the stick member 46 entering into the through hole 11a of the valve body 11, the extraneous material F may be removed from the through hole 11a easily even in a case where the extraneous material F block the through hole 11a.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A coolant control valve, comprising:
a valve body;
a valve seat;
a biasing member biasing the valve body to a side where the valve seat is positioned;
a solenoid generating a magnetic force by being energized, the solenoid making the valve body and the valve seat contact with each other;
a control portion controlling an energization condition of the solenoid; and
a blockage inhibition mechanism; wherein
the valve body is provided at a flow passage of a fluid, the valve body including a magnetic body for controlling a flow of the fluid by coming in contact with the valve seat and by being away from the valve seat;
the valve seat is provided at the flow passage of the fluid, the valve seat including the magnetic body for controlling the flow of the fluid by coming in contact with the valve body and by being away from the valve body;
the valve body includes a through hole into which the fluid flows in a state where the valve body is in contact with the valve seat; and
the blockage inhibition mechanism inhibits an extraneous material within the fluid from blocking the through hole.

2. The coolant control valve according to claim 1, wherein the blockage inhibition mechanism includes an extraneous material collection portion collecting the extraneous material at a position away from the through hole.

3. The coolant control valve according to claim 2, wherein the extraneous material collection portion includes a mesh and each cell of the mesh is smaller than the through hole.

4. The coolant control valve according to claim 2, further comprising:
a tubular portion being protrudingly formed from a portion of the valve body to an upstream side in a flow direction of the fluid; wherein
the through hole is provided at the tubular portion; and
the extraneous material collection portion is provided at a surface portion, the surface portion being provided radially outward of an outer circumference of the tubular portion relative to forward and rearward directions of the tubular portion, the surface portion being provided orthogonal to the flow direction of the fluid.

5. The coolant control valve according to claim 4, wherein
the tubular portion includes a wall portion being provided at the outer circumference of the tubular portion; and
the through hole is positioned through the wall portion of the tubular portion.

6. The coolant control valve according to claim 1, the extraneous material is removed in a case where the fluid flows and in a case where an energizing current value of the solenoid is reduced.

7. The coolant control valve according to claim 1, wherein the blockage inhibition mechanism includes a removal portion removing the extraneous material blocking the through hole.

8. The coolant control valve according to claim 6, wherein the removal portion includes a stick member entering into the through hole of the valve body.
